(19) United States
(12) Patent Application Publication
(10) Pub. No.: US 2018/0057706 A1
(43) Pub. Date: Mar. 1, 2018

(54) Self-healing and Bacteria Resistant Coating Materials for Various Substrates

(71) Applicant: Nano and Advanced Materials Institute Limited, Hong Kong (HK)

(72) Inventors: Hong TAO, Hong Kong (HK); Siyue LI, Hong Kong (HK); Yin Ming NG, Hong Kong (HK); Qiu JIN, Hong Kong (HK)

(21) Appl. No.: 15/682,570

(22) Filed: Aug. 22, 2017

Related U.S. Application Data
(60) Provisional application No. 62/495,073, filed on Sep. 1, 2016.

(51) Int. Cl. C09D 175/04; C08G 18/32; C08B 37/16; C08L 71/08; C08G 65/34; C08G 63/08

(52) U.S. Cl. CPC C09D 175/04; C08G 18/3203; C08B 37/0012; C07F 7/22; C08G 65/34; C08G 63/08; C08L 71/08

(57) ABSTRACT

The present invention provides a coating composition and a method of imparting self-healing, anti-microbial and anti-fouling properties onto a substrate at ambient temperature without external intervention. The coating composition comprises a product of an in-situ polymerization mixture comprising diisocyanate, polyol and saccharide. The polyol is a polyester or a polyether.

### CROSS-REFERENCES TO RELATED APPLICATIONS

This application claims priority to U.S. Provisional Patent Application No. 62/495,073 filed on Sep. 1, 2016; the disclosure of which is incorporated by reference in its entirety.

### FIELD OF THE INVENTION

The present invention relates generally to compositions and methods for providing a self-healing, anti-microbial and anti-fouling coating for different substrate surfaces.

### BACKGROUND OF THE INVENTION

Coatings are often applied onto surfaces to impart protection and surface functionality in industrial, commercial and domestic settings. Coatings may act as a protective barrier to safeguard an underlying substrate against corrosion, erosion, adverse environment and wear. Coatings may also provide additional functionalities to the underlying substrate tailored for specific applications of the substrate. A self-healing coating is desirable; its capability to restore from scratches and cracks increases life cycle and reduces maintenance costs of a product or device on which the coating is applied. Coatings with an anti-microbial property are readily available and practical in the market. However, many existing anti-microbial and/or anti-fouling coating compositions are made from toxic heavy metals and biocides. Thus, use of these existing coating compositions on consumer products is limited. Furthermore, the self-repair property of existing coating compositions is only exhibited upon external treatment, such as exposure to ultraviolet light, carbon dioxide, water, or other external source. Accordingly, there is a need to provide a non-toxic coating composition that can be applied onto a range of substrates, including those that would be in contact with skin, to impart self-healing, antimicrobial and/or antifouling properties to the substrates at ambient temperature without external interventions.

### SUMMARY OF THE INVENTION

The present invention provides a coating composition and a method of imparting self-healing, anti-microbial and anti-fouling properties onto a substrate at ambient temperature without external intervention. Apart from acting as a protective layer of an underlying substrate protecting it from grease, liquids and abrasion like most conventional coatings do, the coating formed by the coating composition of the present invention is self-healing. The present coating restores from scratches and cracks at ambient temperature without external intervention. The coating formed by the present coating composition can returns to its original physical condition, gloss and properties even after multiple abrasions at the same location. Accordingly, product life cycle is increased and maintenance or repair costs are reduced by coating a product surface with the coating composition of the present invention. The coating formed by the present coating composition is also non-toxic, yet resistant to microbes and fouling. Moreover, the coating composition of the present invention exhibits excellent adhesion to a wide range of substrates for use in diverse settings. The non-toxic, anti-microbial and anti-fouling nature of the present coating composition makes the present invention particularly useful in consumer products.

In accordance with one aspect of the present invention, the coating composition comprises a product of in-situ polymerization mixture comprising diisocyanate, polyol, and saccharide, wherein the polyol is a polyester or a polyether. In accordance with one embodiment, the in-situ polymerization mixture comprises diisocyanate, polyester and saccharide, wherein the saccharide is a monosaccharide. In accordance with another embodiment, the polymerization mixture comprises diisocyanate, polyether and saccharide, wherein the saccharide is a polysaccharide.

In accordance with one embodiment, the diisocyanate is selected from hexamethylene diisocyanate, isophorone diisocyanate and 4,4′-dicyclohexylmethane diisocyanate or a combination thereof. The polyester is selected from polycaprolactone diol, polycaprolactone triol, poly(tetramethylene adipate) diol or a combination thereof. Monosaccharide may be methyl-α-d-glucopyranoside, glucose and fructose. The polyether is selected from polyethylene glycol (PEG) and polytetrahydrofuran (PTFH) or a combination thereof. Polysaccharide is cyclodextrin.

In accordance with one embodiment of the present invention, the in-situ polymerization mixture further comprises a biocompatible metal complex. The metal complex is selected from zinc 2-pyrrolidone-5-carboxylate (Zn PCA), zinc acetate, zinc gluconate, zinc pyrrolidone, zinc pyrithione or a combination thereof. In accordance with one embodiment of the present invention, the in-situ polymerization product of the coating composition is grafted with polymer chains. The polymer chain may be a polyether. In one embodiment, the polymer chain is poly(ethylene glycol) methyl ether. In accordance to another embodiment of the present invention, the in-situ polymerization product is polymerized in the presence of catalyst selected from an organotin catalyst, bismuth neodecanoate, zinc acetate or triethylamine. Catalysts applicable for use in in-situ polymerization of isocyanate and polyol is readily appreciated by those skilled in the art. Catalysts, such as organometallic catalyst, act as Lewis acids which accept electrons from oxygen atom of the isocyanate group are applicable in the present invention. Amine catalysts, such as trimethylamine, act as Lewis bases which donate lone pair of electrons to the carbon atom of the isocyanate group is also applicable in the present invention.

In accordance with a second aspect of the present invention, a method of imparting a self-healing, anti-microbial and anti-fouling surface onto a substrate comprises applying a coating composition comprising a product of an in-situ polymerization mixture comprises diisocyanate, polyol, saccharide and biocompatible metal complex, wherein the polyol is a polyester or a polyether. In accordance with one embodiment, the in-situ polymerization mixture comprises diisocyanate, polyester and saccharide, wherein the saccharide is a monosaccharide. In accordance with another embodiment, the polymerization mixture comprises diisocyanate, polyether and saccharide, wherein the saccharide is a polysaccharide.

In accordance with one embodiment of the second aspect of the present invention, the substrate comprises glass, ABS, ABS/PC, PC, PMMA, Al alloys, Ti alloys, and stainless steel. In accordance with another embodiment of the second aspect of the present invention, the applying step comprises molding, spraying, brushing, rolling, painting and spinning.

### BRIEF DESCRIPTION OF THE DRAWINGS

Embodiments of the invention are described in more detail hereinafter with reference to the drawings, in which:

FIG. 1 depicts the coating composition of the present invention applied on different substrates;

FIG. 2 depicts a synthetic step of a HDI-PCL polymer network (FIG. 2a) and an in-situ polymerization product (FIG. 2b) of the coating composition in accordance to one embodiment of the present invention;

FIG. 3 depicts FTIR spectrum of the coating formed from the coating composition made of the polymer of FIG. 2a with (FIG. 3a) bismuth neodecanoate or (FIG. 3b) trimethylamine as catalyst and in-situ polymerization product of FIG. 2b in the presence of organotin (FIG. 3c);

FIG. 4 depicts a synthetic step of an in-situ polymerization product of the coating composition in accordance with another embodiment of the present invention;

FIG. 5 depicts FTIR spectrum of the coating formed from the coating composition made of the in-situ polymerization product of FIG. 4;

FIG. 6 depicts microscopic images of coating formed from the coating composition in accordance with one embodiment of the present invention after being scratched by a brass brush;

FIG. 7 depicts FTIR spectrum of the ZnPCA loaded coating composition in accordance with one embodiment of the present invention; and

FIG. 8 depicts an in-situ polymerization product of the coating composition in accordance to one embodiment of the present invention.

### DETAILED DESCRIPTION OF THE INVENTION

In the following description, a coating composition and a method of imparting self-healing, anti-microbial and anti-fouling properties onto a substrate at ambient temperature without external intervention are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance to one aspect of the present invention, the coating composition comprises a product of a in-situ polymerization mixture comprises diisocyanate, polyol and saccharide, wherein the polyol is a polyester or a polyether. In accordance with one embodiment, the coating composition comprises at least two different in-situ polymerization products. In accordance with another embodiment, the coating composition comprises one in-situ polymerization product. The molar ratio of the diisocyanate and polyol in the in-situ polymerization mixture of the present composition is crucial for the self-healing performance. The molar ratio determines the number of carbamate groups in the polyurethane network which provide the hydrogen bonding interactions leading to a self-healing coating. The hydrogen bonds are readily broken and reformed without external intervention giving the self-healing property of the present coating composition. The molar ratio of diisocyanate to polyol is in the range of 2.2:1 to 8:1. In one embodiment, the molar ratio of diisocyanate to polyol is in the range of 2.2:1 to 5:1, 2.2:1 to 6:1 and 3:1 to 6:1. In one embodiment, the molar ratio of diisocyanate to polyol is 4.5:1. The coating composition of the present invention self-repairs from mechanical damage, such as scratches and abrasions, under ambient conditions and without external intervention. Ambient conditions refer to normal atmospheric temperature and pressure. In conventional self-healing coating compositions, their self-healing property is only expressed when the coating is exposed to some external source, such as UV light, carbon dioxide, water or other sources like metal ions. For example, in US2016/0289495, imine (C═N) bond of the 1,3,5-oxadiazinane-2,4-dione ring of the disclosed polyurethane polymer undergo cycloaddition reaction, when activates by IN light, to give the self-healing property. Unlike the conventional coating composition, the self-healing/repair property of coating formed from the coating composition of the present invention is exhibited once the coating composition is dried and a coating is formed on the substrate. No external intervention or input is required. Coating of the coating composition of the present invention recovers from damage such as fine scratches to deep cracks. Coatings of the present coating composition recover to their original condition and gloss even after multiple rounds of damage.

Aliphatic isocyanates are preferred in the present invention. The lower reactivity of aliphatic isocyanates with water reduces hydrolysis of isocyanate group. The diisocyanate is selected from hexamethylene diisocyanate (HDI), isophorone diisocyanate (IPDI) and 4,4′-dicyclohexylmethane diisocyanate (H₁₂MDI).

In accordance with one embodiment, the in-situ polymerization mixture comprises diisocyanate, polyester and saccharide, wherein the saccharide is a monosaccharide. The monosaccharide is selected from methyl-α-d-glucopyranoside, glucose and fructose.

In one embodiment, the diisocyanate of the present coating composition is an organic compound having at least two —NCO reactive functional groups in order to react with —OH reactive groups in the polyesters to form a polyurethane network. The polyester contributes to the soft segments of the polyurethane network. The polyester is selected from polycaprolactone diol (PCL diol), polycaprolactone triol (PCL triol), and poly(tetramethylene adipate) diol. The self-healing/repair property of the present coating composition is due to the elastic polymer network of the in-situ polymerization product. In this embodiment, the polyurethane network of the present coating composition is made up of hard segments of the diisocyanate and the saccharide, and soft segments of polyester. The formation of the polyurethane network from the diisocyanate, polyester and monosaccharide is catalyzed by a catalyst that includes, but is not limited to, organotin, bismuth neodecanoate, zinc acetate or trimethylamine. While coating of the present coating composition demonstrates elasticity for self-healing, the coating is also strong to provide protection on the underlying substrate. The coating expresses a hardness of up to 6H. The polyurethane network is a network of polymer composed of organic units joined by carbamate links (—NH—C(═O)—O—) which provides hydrogen bonding for self-healing. The hydrogen bonds between the hard (diisocyanate and saccharide) and soft (polyester) segments can readily break and reform without external intervention giving the self-healing property of the present coating composition.

In accordance with another embodiment, the in-situ polymerization mixture comprises diisocyanate, polyether and saccharide, wherein the saccharide is a polysaccharide. The polyether is selected from polyethylene glycol (PEG) and polytetrahydrofuran (PTFH). Polysaccharide is a cyclic polysaccharide, including but is not limited to, cyclodextrin. The polyurethane backbone is formed by diisocyanate and polyether. In accordance with this embodiment, a slide-ring network formed by cross-linking cyclic polysaccharides, such as cyclodextrin, on the polyurethane backbone additionally contributes to the self-healing/repair property of the present coating composition. The cyclic polysaccharides form a supermolecular architecture with entropic elasticity. The cyclic polysaccharides lead sliding movement within the polyurethane network to result in self-repairing of the present coating composition in addition to the hydrogen bonding between the diisocyanate and polyether. The formation of the polyurethane network from the diisocyanate and polyether and polysaccharide is catalyzed by a catalyst which include, but is not limited to, organotin, bismuth neodecanoate, zinc acetate or trimethylamine. While coating of the present coating composition demonstrates supramolecular architecture with entropic elasticity for self-healing, the coating is also strong to provide protection on the underlying substrate. The coating expresses a hardness of up to 4H.

In accordance with one embodiment, the coating formed from the coating composition of the present invention also exhibits anti-microbial property. The coating of the present coating composition is effective in controlling and eliminating proliferation of bacteria and fungus, including gram-positive and gram-negative bacteria, e.g. E. coli and S. aureus. In this embodiment, the coating composition further comprises metal complexes. Metal complexes suitable for the present invention are biocompatible and non-toxic. The metal complexes may be, but are not limited to, zinc 2-pyrrolidone-5-carboxylate (Zn PCA), zinc acetate, zinc gluconate, zinc pyrrolidone, zinc pyrithione and a mixture thereof. Metal complexes dissolved in organic solvent are added before or during the in-situ polymerization process such that the metal complexes are dispersed in the polyurethane network.

In accordance with one embodiment, the coating formed from the coating composition of the present invention exhibits an anti-fouling property. The anti-fouling property is imparted through grafting of polymer chains onto the polyurethane backbone of the coating composition. The in-situ polymerization product is coupled with polymer chains. Polymer chains suitable for the present invention are readily appreciated by the skilled in the art as polymer chains that provide low interfacial energy to the coating surface, such as polyether. The polymer chains on the surface of the coating prevent adhesion of bacteria and or other microorganisms on the coated surface. In this embodiment, polymer chain for incorporation to the polyurethane segment includes, but is not limited to, poly(ethylene glycol) methyl ether (mPEG).

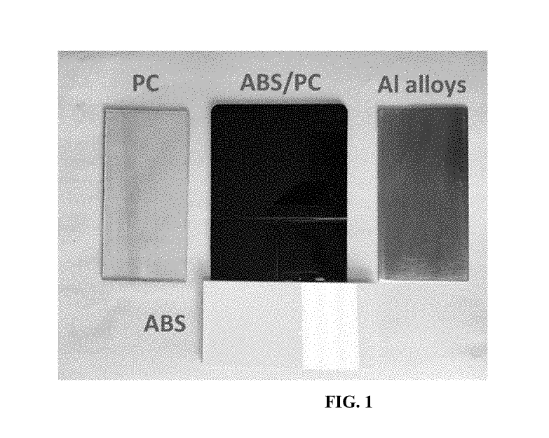

The coating composition of the present invention can be applied onto various substrate surfaces with good adhesions enabling it to be applicable to a wide range of settings. The non-toxic, anti-microbial and anti-fouling characteristics of the present coating composition allow its applications in consumer products, while protecting the underlying substrate and increasing the product life cycle via its self-repairing nature. In accordance with one embodiment of the present invention, the coating composition may be applied onto variety of substrates (FIG. 1). As seen in FIG. 1, the present coating composition is transparent and can adhere onto various substrates without changing the appearance of the substrate. The substrates include, but are not limited to, glass; polymer surfaces such as ABS, ABS/PC, PC, PMMA; metal surfaces including metal alloys, such as Al alloys, Ti alloys, and stainless steel.

In accordance with the second aspect of the present invention, the present invention provides a method of imparting a self-healing, anti-microbial and anti-fouling surface onto a substrate. The method comprises applying the coating composition comprises the aforesaid in-situ polymerization product of diisocyanate, polyol and saccharide, wherein the polyol is a polyester or polyether. The coating composition of the present invention may be applied onto the substrate by conventional means which results in a continuous smooth coating as would be appreciated by those skilled in the art. Application means include, but is not limited to, molding, spraying, brushing, rolling, T-die coating, dipping, painting and spinning. The present method includes applying the coating composition by dispensing, ink-jet printing, screen printing or offset printing to achieve more precise and localized application of the coating composition.

In the present application, the terms “self-healing” and “self-repairing” are used interchangeably and refer to an ability to return to original condition and gloss after abrasion and mechanical damage under ambient condition without external input. The original condition and gloss of a coating is the condition and gloss of the coating before abrasion and mechanical damage. The self-healing, anti-microbial and anti-fouling and other functional properties of the coating composition of the present invention are revealed in the below examples. The description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated.

One skilled in the art would readily appreciate that different functions discussed herein may be performed in a different order and/or concurrently with each other. Many modifications and variations will be apparent to the practitioner skilled in the art. Furthermore, if desired, one or more of the embodiments described herein may be optional or may be combined. Other aspects and advantages of the present invention will be apparent to those skilled in the art from a review of the present application.

### EXAMPLES

### Example 1

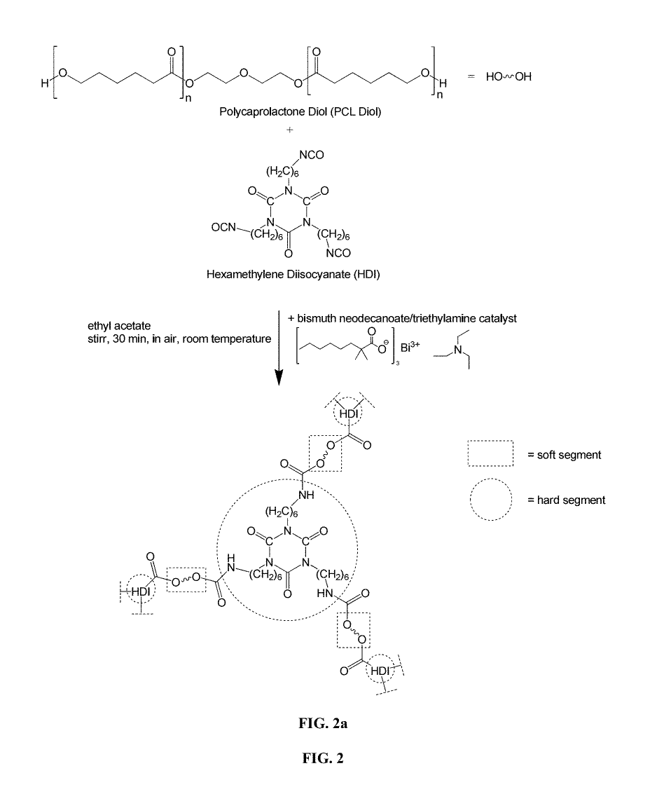

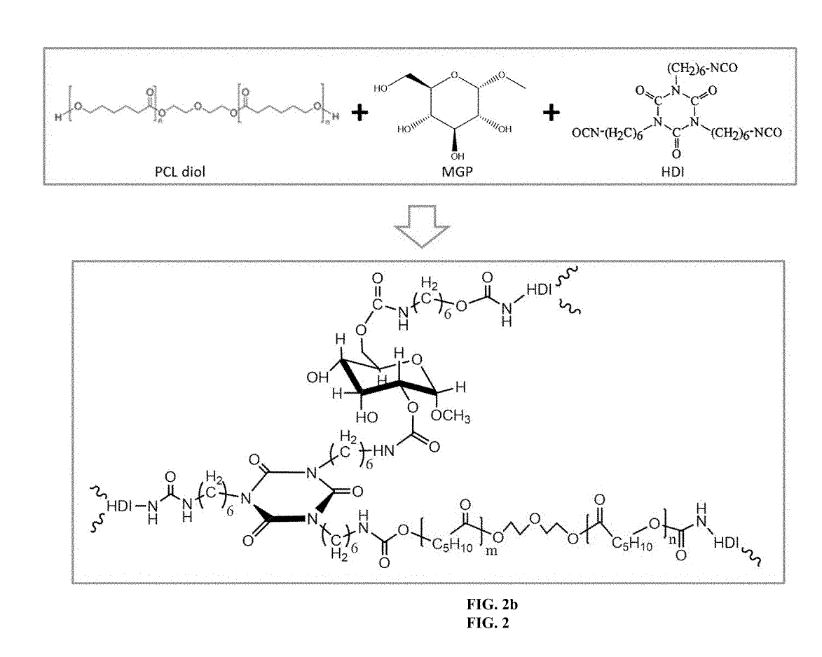

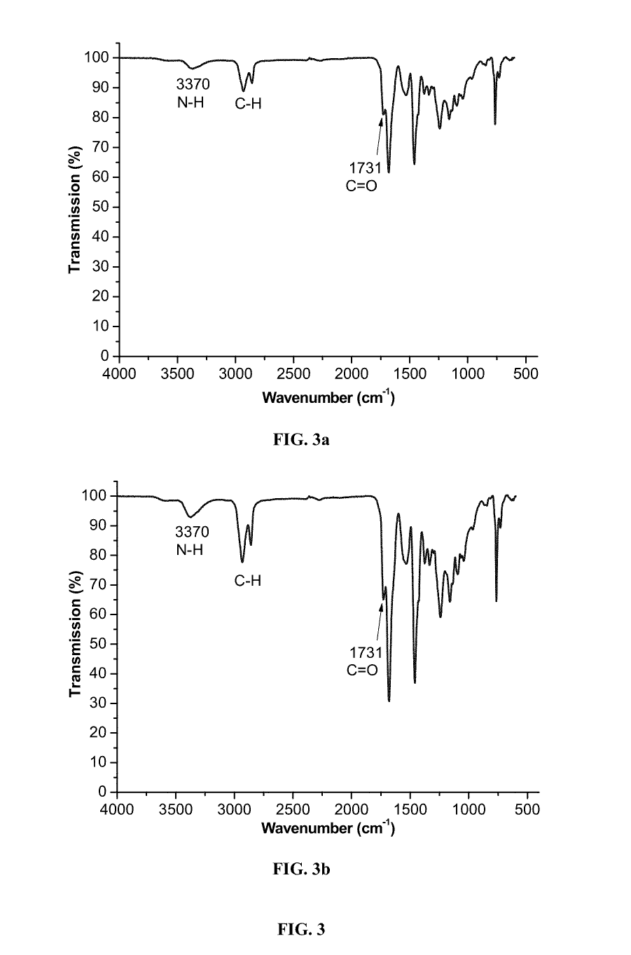

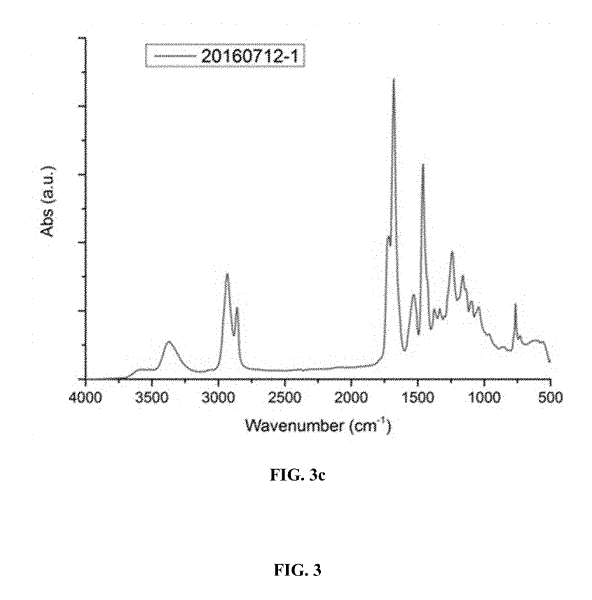

In accordance with one embodiment of the present invention, the polymer (PCL-HDI) network is made by an in-situ polymerization of hexamethylene diisocyanate trimer (HDI) and polycaprolactone diol (PCL diol). The polymerization is performed in the presence of bismuth neodecanoate or trimethylamine catalyst. The polymer network is elastic and gives the self-healing property to the coating of the present coating composition. The polymer network consists of a hard segment of HDI and a soft segment of PCL diol. FIG. 2a shows the synthesis of a PCL diol-HDI polymer network in accordance with one embodiment of the present invention. ATR-FTIR spectrum of PCL diol-HDI polymer film in the presence of two different catalysts in shown in FIGS. 3a and 3b. In this example, the isocyanate in HDI reacts with the OH group in PCL diol to form carbamate links, resulting in a formation of polyurethane network with hydrogen bonds for self-healing. The molar ratio of isocyanate to polyester in the range of 2.2:1 to 8:1 provides self-healing of the coating composition, even in the absence of saccharide.

An in-situ polymerization product of one embodiment of the present coating composition is synthesized from HDI, PCL diol and methyl-α-d-glucopyranoside (MGP) as the saccharide in the presence of tin catalyst (FIGS. 2b and 3c). The in-situ polymerization product forms a polymer network including a hard segment of the polyurethane (HDI and MGP) and a soft segment of PCL diol. The elasticity of the crosslinked polymer network enables the coating to heal instantly from scratches.

### Example 2

In accordance with one embodiment of the present invention, the polymer (PCL triol-HDI) network is made by an in-situ polymerization of hexamethylene diisocyanate trimer and polycaprolactone triol. The polymerization is performed in the presence of bismuth neodecanoate. The polymer network is elastic and gives the self-healing property to the coating of the present coating composition. The polymer network consists of a hard segment of HDI and a soft segment of PCL triol.

### Example 3

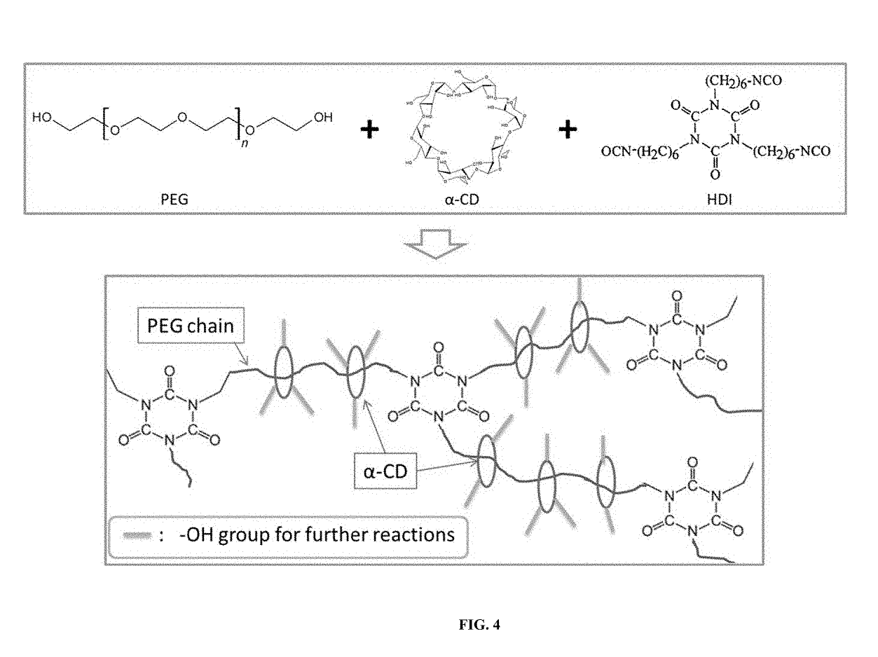

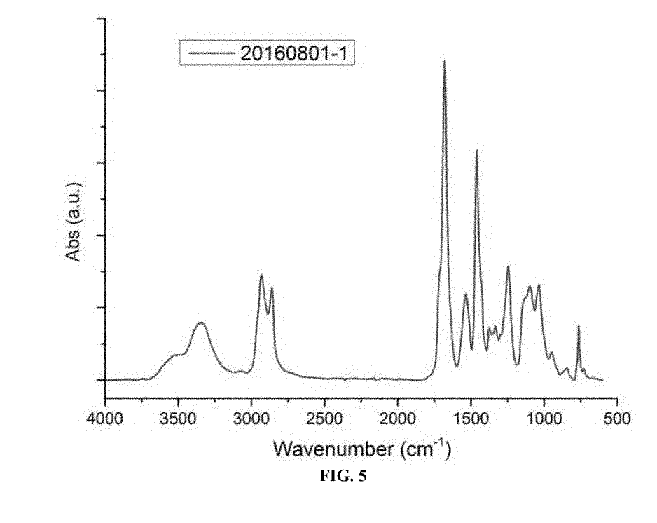

A polymer network in accordance with another embodiment of the present invention consists of polyurethane backbone formed by HDI and PEG, and cyclodextrin as side chains. The cyclodextrin rings are introduced to PEG, and —NCO groups of HDI react with —OH groups of PEG in the presence of organotin catalyst. FIG. 4 shows the synthesis scheme of HDI-PEG-Cyclodextrin polymer network. FIG. 5 is ATR-FTIR spectrum of HDI-PEG-Cyclodextrin polymer. The self-healing ability is achieved by hydrogen bonding of polyurethane backbone, and sliding and movement of cyclodextrin rings along the polyurethane chains.

### Example 4

A polymer network in accordance with another embodiment of the present invention consists of polyurethane backbone formed by HDI and PTFH and cyclodextrin side chains. The cyclodextrin rings are introduced to PTFH, and —NCO groups of HDI react with —OH groups of PTFH in the presence of bismuth neodecanoate catalyst. The self-healing ability is achieved by hydrogen bonding of polyurethane backbone, and sliding and movement of cyclodextrin rings along the polyurethane chains.

### Example 5

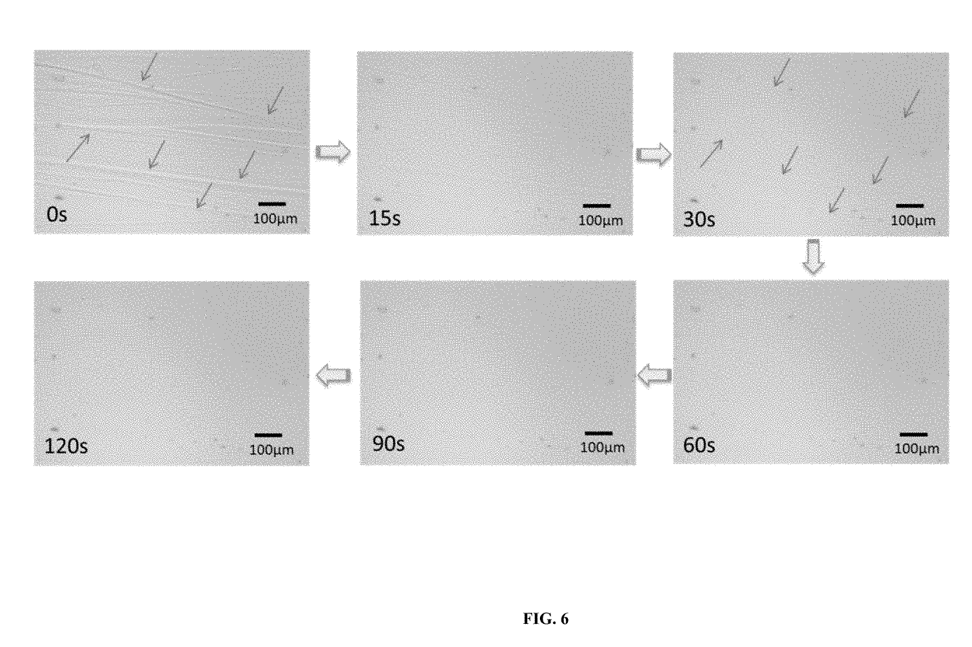

The self-healing property of the PCL diol-MGP-HDI coating is shown. The present coating composition is applied onto substrate and is allowed to dry to form a coating. The coated substrate is scratched with a brass brush. FIG. 6 shows the polymer coating of the present invention after being scratched by a brass brush. The polymer coating of the present invention recovers to its original condition within 2 minutes.

Substrate coated with the coating composition of the present invention is subject to scratch tester (ISO 1518:1973; GB9279:88) under 1000 g. It is demonstrated that the coating recovers to its original condition within 5 minutes.

### Example 6

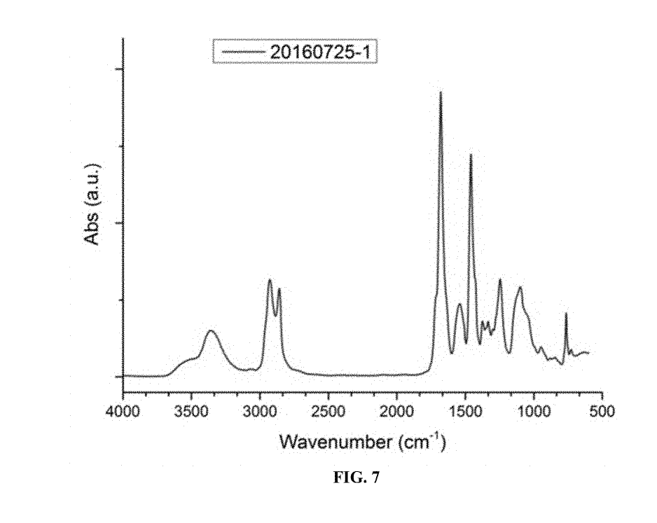

Anti-microbial property of the coating composition of the present invention is investigated. Zinc complexes dissolved in an organic solvent are added before or during the in-situ polymerization process of diisocyanate, polyester and saccharide to disperse the zinc complexes into the polymer network. FIG. 7 shows the ATR-FTIR spectrum of Zn PCA loaded HDI-PCL-MGP coating composition. The coating composition of the present invention is applied onto a substrate and allowed to dry. Antibacterial activity is confirmed by ISO 22196.

### Example 7

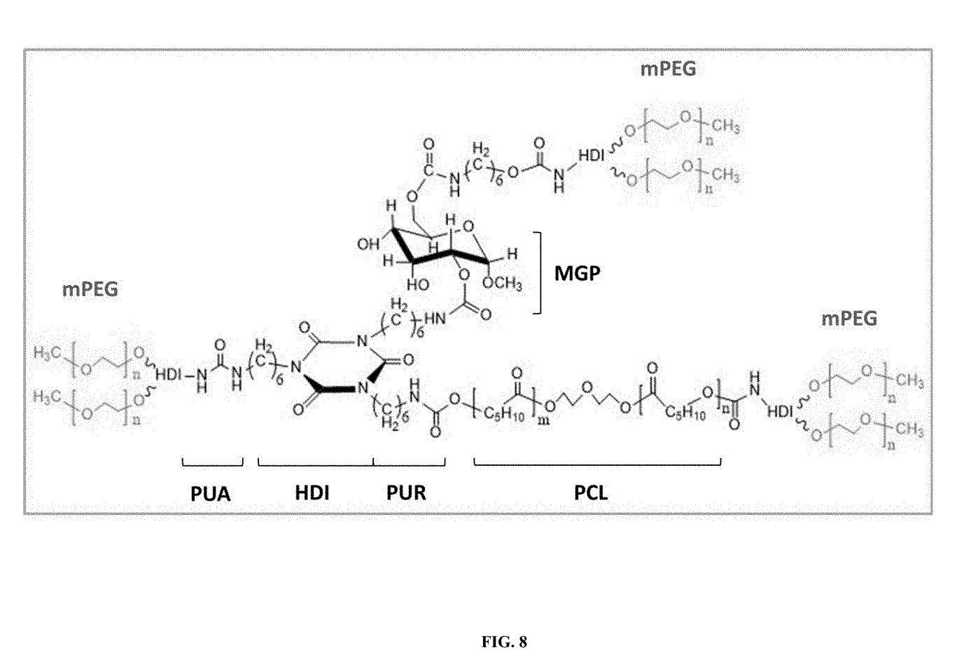

Anti-fouling performance of the present coating composition is formulated (FIG. 8) and investigated. MGP, PCL diol are dissolved in mixed organic solvents. HDI is diluted by ethyl acetate and is added to the mixture of MGP/PCL diol in the presence of dibutyltin dilaurate at 25° C. under N₂ protection. The mixture is allowed to react for 30 mins. Thereafter, poly(ethylene glycol) methyl ether (mPEG) is added to the reaction mixture. mPEG is grafted to the polyurethane backbone through coupling of unreacted isocyanate groups of HDI and —OH groups of mPEG at 25° C. under N₂ protection, obtaining a coating composition which results in a transparent coating on various substrates. Substrates coated with mPEG modified coating compositions are tested by a bacteria adhesion test. It is shown that the mPEG modified coating composition of the present invention reduces bacterial adhesion significantly, owning to the dynamic motion of the mPEG chains.

### Example 8

Table 1 below shows the self-healing performance and change of appearance of a substrate having been coated with the coating composition of the present invention under various tests. It is demonstrated that the coating of the present coating composition is able to self-heal, recovers to its original physical condition and appearance, and has high gloss after repeated rounds of mechanical damage. The coating is also resistant to water, solvent, chemical and heat. The coating self-heals and appearance remains the same after exposure to water, solvent, chemical, heat and abrasion.

| | | Self- | Appear- |
|---|---|---|---|
| | Evaluation | healing | ance |
| Instant self- | Brass brush under 1000 g force, | ✓ | ✓ |
| healing | 1000 cycles | | |
| performance | | | |
| Water | Salt spray (5% NaCl, 35° C.) 200 hrs | ✓ | ✓ |
| resistance | Immersed in 5% H₂SO₄, RT, 100 hrs | ✓ | ✓ |
| | Immersed in H₂O, RT, 100 hr | ✓ | ✓ |
| Abrasion | Eraser test: 200 cycles under 500 g | ✓ | ✓ |
| resistance | force | | |
| Solvent | Wiped by MEK rinsed cloth 100 times | ✓ | ✓ |
| resistance | Wiped by EA rinsed cloth 100 times | ✓ | ✓ |
| Chemical | Covered by Hand Cream for 24 hrs | ✓ | ✓ |
| resistance | | | |
| Heat | 80° C. × 2 hrs [symbol] 40° C. × 2 hrs for | ✓ | ✓ |
| resistance | 5 cycles | | |
| | −10° C., 5 min | ✓ | ✓ |
| | 200° C., 5 min | | |

Table 1 shows the results of the present coating composition after various physical tests.

### Example 9

| | diisocyanate | | polyol | saccharide | catalyst | |
|---|---|---|---|---|---|---|
| 1 | 5.0 | g HDI | 3.5 g PCL diol | / | 0.04 g Bismuth or | |
| | | | (MW = 530) | | 0.1 g trimethylamine | |
| | | | | | or 0.05 g zinc acetate | |
| 2 | 5.0 | g HDI | 4 g PCL diol | 0.157 g | 0.0001 | g DBTL |
| | | | (MW = 530) | MGP | | |
| 3 | 5.0 | g HDI | 4 g PCL triol | / | 0.04 | g Bismuth |
| | | | (MW = 900) | | | |
| 4 | 4 | g HDI | 1.6 g PEG | 1 g | 0.0001 | g DBTL |
| | | | (MW = 300) | α-Cyclo- | | |
| | | | | dextrin | | |
| 5 | 4.66 | g HDI | 3 g PTFH | 1 g | 0.04 | g Bismuth |
| | | | (MW = 650) | α-Cyclo- | | |
| | | | | dextrin | | |

The foregoing examples illustrate the protective capability of the coating of the present coating composition against mechanical, chemical, water and heat damage. It is also capable of imparting anti-microbial and anti-fouling properties onto the underlying substrate without changing the appearance of the substrate.

While the foregoing invention has been described with respect to various embodiments and examples, it is understood that other embodiments are within the scope of the present invention as expressed in the following claims and their equivalents. Moreover, the above specific examples are to be construed as merely illustrative, and not limitative of the reminder of the disclosure in any way whatsoever. Without further elaboration, it is believed that one skilled in the art can, based on the description herein, utilize the present invention to its fullest extend. All publications recited herein are hereby incorporated by reference in their entirety.

1. A coating composition comprising a product of an in-situ polymerization mixture comprises diisocyanate, polyol, and saccharide, wherein the polyol is polyester or polyether and wherein the molar ratio of diisocyanate to polyol is 2.2:1 to 8:1 and the diisocyanate and the polyol form a polymer backbone joined by carbamate linkage that provides hydrogen bonding to impart self-healing property to the coating composition.

2. The coating composition of claim 1, wherein the mixture comprises diisocyanate, polyester and monosaccharide or the mixture comprises diisocyanate, polyether and polysaccharide.

3. The coating composition of claim 3, wherein the mixture further comprises catalyst selected from organotin, bismuth neodecanoate, zinc acetate, triethylamine and a combination thereof.

4. The coating composition of claim 3, the in-situ polymerization mixture further comprises a metal complex or a polymer capable to provide low interfacial energy to the in-situ polymerization product, or both.

5. The coating composition of claim 2, wherein the diisoyanate is selected from hexamethylene diisocyanate, isophorone diisocyanate and 4,4′-dicyclohexylmethane diisocyanate, the polyester is selected from polycaprolactone diol, polycaprolactone triol, and poly(tetramethylene adipate) diol and the monosaccharide is selected from methyl-α-d-glucopyranoside, glucose and fructose.

6. The coating composition of claim 2, wherein the polyether is selected from polyethylene glycol (PEG) and polytetrahydrofuran (PTFH) and the polysaccharide is cyclodextrin.

7. The coating composition of claim 4, wherein the metal complex is selected from zinc 2-pyrrolidone-5-carboxylate (Zn PCA), zinc acetate, zinc gluconate, zinc pyrrolidone, zinc pyrithione or a combination thereof.

8. The coating composition of claim 4, wherein the polymer is poly(ethylene glycol) methyl ether.

9. The coating composition of claim 1, wherein the molar ratio of diisocyanate to polyol is 4.5:1.

10. A method of imparting a self-healing protective coating onto a substrate comprising applying the coating composition of claim 1 onto the substrate and allowing the coating composition to dry.

11. A method of imparting a self-healing protective and anti-microbial onto a substrate comprising applying the coating composition of claim 4 onto the substrate and allowing the coating composition to dry.

12. A method of imparting a self-healing protective, and anti-fouling coating onto a substrate comprising applying the coating composition of claim 4 onto the substrate and allowing the coating composition to dry.
